(19) United States
(12) Patent Application Publication
(10) Pub. No.: US 2005/0234810 A1
(43) Pub. Date: Oct. 20, 2005

(54) Joint purchase reverse auction control method, computer program product and server

(75) Inventors: Seiji Goto, Tokyo (JP); Satoshi Okada, Tokyo (JP); Katsuhisa Furuichi, Tokyo (JP); Masazumi Yoshikawa, Tokyo (JP); Hitomi Matsumoto, Tokyo (JP)

Correspondence Address: EDWARDS & ANGELL, LLP, P.O. BOX 55874, BOSTON, MA, 02205, US

(73) Assignee: DeeCorp Limited, Tokyo (JP)

(21) Appl. No.: 11/111,143

(22) Filed: Apr. 20, 2005

(30) Foreign Application Priority Data
Apr. 20, 2004 (JP) 2004-124405

(51) Int. Cl. G06F 17/60

(52) U.S. Cl. 705/37

(57) ABSTRACT

A method for controlling joint purchase reverse auction. The method first determines a contract price for a total procurement amount putting together purchase desires of a plurality of buyers according to a bid by at least one supplier. Then, it calculates a contract price of each buyer from the contract price for the total procurement amount at least according to a purchase scale of the buyer or a procurement price prior to reverse auction of the buyer.

### BACKGROUND OF THE INVENTION

1. Field of the Invention

The present invention relates to a reverse auction system through a communication network and particularly to a joint purchase reverse auction system which conducts reverse auction according to desired purchase terms that puts together purchase desires of a plurality of buyers and determines a successful supplier.

2. Description of Related Art

Electronic purchase services that procure a product or service, which is referred to hereafter as an item, over the internet becomes common. Recently, B-to-B service that is intended for business-to-business transaction, not only B-to-C service that targets general consumers, is on the increase. One form of the electronic purchase service is a reverse auction service.

The reverse auction service starts upon buyer's presentation of desired purchase terms such as specifications of desired product, price, quantity, and delivery date, delivery place. In this auction, suppliers who can satisfy the buyer's terms of purchase submit their bids. This is called “reverse auction” because roles of supplier and buyer are opposite from a normal auction called forward auction in which buyers submit bids in order to obtain a product presented by a supplier. The reverse auction is suitable for business-to-business transaction since terms of purchase such as desired specifications, delivery date, and delivery method vary by buyer in many cases.

The reverse auction service involves one-on-one reverse auction and joint purchase reverse auction. The one-on-one reverse auction conducts reverse auction based on a single buyer's purchase desire and determines a single successful supplier. The joint purchase reverse auction, on the other hand, conducts reverse auction for a total procurement amount that puts together purchase desires of a plurality of buyers and determines a successful supplier. The joint purchase reverse auction has an advantage of profiting volume merit even if the procurement amount of each buyer is small. Japanese Unexamined Patent Publication No. 2001-319098 (Takada) and Japanese Unexamined Patent Publication No. 2002-109286 (Hikita) disclose a system for the joint purchase reverse auction.

A general process of conducting the joint purchase reverse auction is as follows. First, the process gathers buyers and suppliers who participate in the auction. Then, it determines a starting price of the reverse auction from the quantity and price of the item which the participating buyers desire to purchase. Then, the participating suppliers submit bids, and a supplier who submits the lowest price is determined to be a successful bidder. In the joint purchase revere auction, the suppliers normally bid for a total amount that puts together purchase desires of all the participating buyers. After that, the process determines a contract price of each individual buyer based on the obtained contract price, thereby ending the revere auction.

When determining the contract price of each of the participating buyers in the joint purchase revere auction, it is necessary to distribute the amount reduced by the reverse auction, which is referred to hereafter as a reduction amount, properly to the participating buyers.

A conventional method of determining a contract price of each individual participating buyer is as follows. To simplify the description, it is assumed that procurement items of all buyers are the same, and a successful supplier is determined as a result that suppliers bid for a total procurement quantity of participating buyers. One of the conventional methods for determining a contract price of each buyer is to set the price of the contract price divided by a total procurement quantity to be a common contract price of all participating buyers. In this method, however, if the purchase unit price of a procurement item before reverse auction, which is referred to hereafter as a past unit price, significantly varies by buyer, a price reduction effect of reverse auction for the buyer with a low past unit price is relatively small. It is therefore difficult to carry out the reverse auction as a joint purchase when a past unit price significantly varies between buyers.

Further, the above contract price determination method implicitly provides volume merit obtained by mass procurement of items in joint purchase in the form of reduction in the bid price of suppliers. However, it is necessary in some cases to clearly provide the volume merit by allocating the reduction amount preferentially to the buyer with a large procurement quantity. Particularly, if the purchase quantity widely varies between participating buyers, it is apparent that the presence of the buyer with a large purchase quantity benefits other buyers in the reduction amount obtained by reverse auction. This causes the buyer with a large purchase quantity to have feeling of unfairness, which may result in a difficulty in conducting the reverse auction as a joint purchase.

Therefore, if the purchase quantity of participating buyers differs widely and the presence of a specific buyer with a large purchase quantity allows reducing a contract price, it is preferred to allocating the reduction amount obtained by the reverse auction preferentially to the buyer with a large procurement quantity.

### SUMMARY OF THE INVENTION

In view of the foregoing, it is an object of the present invention to provide a control method of joint purchase reverse auction that determines a contract price for a total procurement amount of participating buyers which is capable of determining a contract price or contract unit price of each individual buyer by reflecting either or both of a buyer's procurement scale and past price before reverse auction, and a computer program product and a server for causing a computer to execute this method.

According to one aspect of the present invention, there is provided a joint purchase reverse auction control method. The method includes determining a contract price for a total procurement amount putting together purchase desires of a plurality of buyers according to a bid by at least one supplier, and calculating a contract price of each buyer from the contract price for the total procurement amount at least according to a purchase scale or a procurement price prior to reverse auction of the buyer.

This method allows either or both of the buyer's purchase scale and past price (procurement price before conducting reverse auction) to be counted in determining the contract price of each individual buyer. It is thereby possible to determine the contract price or contract unit price of each buyer that reflects either or both of the buyer's purchase scale and past price.

It is preferred that the contract price of each buyer is calculated in such a way that a price per unit quantity of the contract price of each buyer is lower for a buyer with a larger purchase scale and a lower procurement price prior to reverse auction. This allows allocating the price reduction effect obtained by the reverse auction preferentially to the buyer with a low past price or a large purchase scale.

According to another aspect of the present invention, there is provided a computer program product for causing a computer to execute control of joint purchase reverse auction. The computer program product includes a computer readable medium storing a program code. The program code includes a first program code determining a contract price for a total procurement amount putting together purchase desires of a plurality of buyers according to a bid by at least one supplier, and a second program code calculating a contract price of each buyer from the contract price for the total procurement amount at least according to a purchase scale or a procurement price prior to reverse auction of the buyer.

This allows either or both of the buyer's purchase scale and past price (procurement price before conducting reverse auction) to be counted in determining the contract price of each individual buyer. It is thereby possible to determine the contract price or contract unit price of each buyer that reflects either or both of the buyer's purchase scale and past price.

According to another aspect of the present invention, there is provided a server for implementing control of joint purchase revere auction. The server includes a unit of determining a contract price for a total procurement amount putting together purchase desires of a plurality of buyers according to a bid by at least one supplier, and a unit of calculating a contract price of each buyer from the contract price for the total procurement amount at least according to a purchase scale or a procurement price prior to reverse auction of the buyer.

This configuration allows either or both of the buyer's purchase scale and past price (procurement price before conducting reverse auction) to be counted in determining the contract price of each individual buyer. It is thereby possible to determine the contract price or contract unit price of each buyer that reflects either or both of the buyer's purchase scale and past price.

It is preferred that the unit of determining a contract price calculates the contract price of each buyer in such a way that a price per unit quantity of the contract price of each buyer is lower for a buyer with a larger purchase scale and a lower procurement price prior to reverse auction. This allows allocating the price reduction effect obtained by the reverse auction preferentially to the buyer with a low past price or a large purchase scale.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram showing the entire configuration of a reverse auction system of the present invention;

FIG. 2 is a block diagram of a server;

FIG. 3 is a view showing an example of a buyer information table;

FIG. 4 is a view showing an example of a supplier information table;

FIG. 5 is a view showing an example of a desired purchase terms table;

FIG. 6 is a view showing an example of a joint purchase case table;

FIG. 7 is a flowchart showing the process of a reverse auction system of the present invention;

FIG. 8 is a flowchart showing a contract unit price calculation routine of the present invention;

FIG. 9 is a graph showing an example of a contract unit price calculation result;

FIG. 10 is a graph showing an example of a contract unit price calculation result; and

FIG. 11 is a view showing an example of a desired purchase terms input screen.

### DESCRIPTION OF THE PREFERRED EMBODIMENTS

Preferred embodiments of the present invention are described hereinafter with reference to the drawings.

### First Embodiment

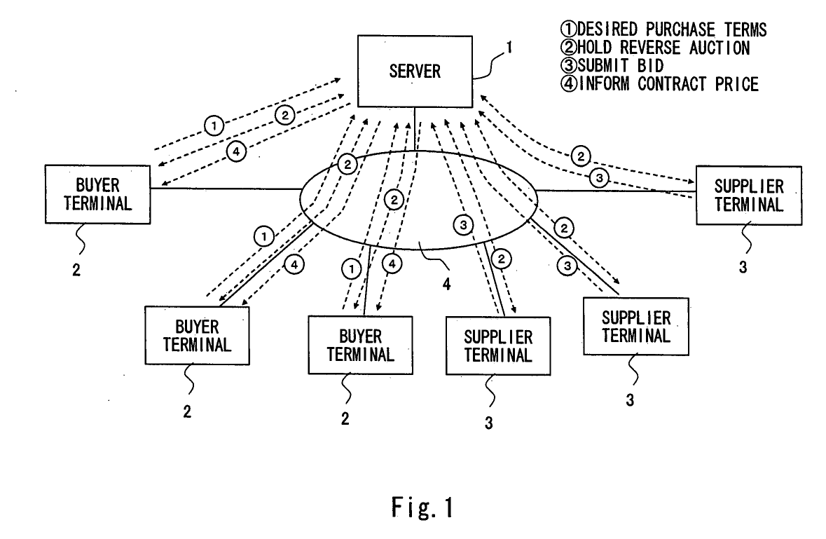

FIG. 1 is the block diagram showing the entire configuration of a reverse auction system according to a first embodiment of the invention. The system includes a server 1, at least one buyer terminal 2, and at least one supplier terminal 3, which are connected through a network 4.

The server 1 acquires and controls desired purchase terms transmitted from the buyer terminal 2, bidding information transmitted from the supplier terminal 3, and so on, and conducts reverse auction. The buyer terminal 2 is a terminal used by a buyer who is a user of a reverse auction service. The supplier terminal 3 is a terminal used by a supplier who is a user of the reverse auction service. The buyer is a purchaser who desires to procure a product or service through the use of the reverse auction service. The supplier is a seller who desires to offer a product or service through the use of the reverse auction service.

Referring first to FIG. 1, an overview of the operation of the reverse auction system of this embodiment is described. Firstly in this system, a plurality of buyer terminals 2 transmit to the server 1 the desired purchase terms for an item they desire to procure in reverse auction. The desired purchase terms are information including the name of a desired product or service, an expected purchase scale, a past unit price and a desired unit price. The expected purchase scale is information about a purchase volume that is a price determination factor of a procurement target item. If the procurement target is a product, the expected purchase scale is a procurement quantity. If the procurement target is a service, on the other hand, the expected purchase scale is a value to specify the scale of service, and it is the number of hours in temporary personnel service, the number of words in translation service, the area of a floor to be cleaned in a cleaning service, and so on. The past unit price is a unit price which a buyer has used when purchasing a product or service before conducting reverse auction, which serves as a reference for measuring the price reduction effect of reverse auction.

Then, the server 1 puts together the desired purchase terms transmitted from a plurality of buyer terminals 2 and determines the terms required for making a joint purchase. The terms required for making a joint purchase includes participating buyers, participating suppliers, a starting price of joint purchase reverse auction, a date to hold joint purchase reverse auction, and so on. The server 1 implements joint purchase reverse auction based on the terms for a joint purchase. In the joint purchase reverse auction, the supplier terminals 3 transmit bidding information input by a supplier to the server 1, and the server 1 compares transmitted bidding information and determines a successful supplier and a contract price.

After that, the server 1 determines a contract price of each individual buyer by reflecting the purchase scale and past unit price of each participating buyer based on the contract price determined for the total purchase amount of all the participating buyers. The server 1 then transmits the contract price of each individual buyer to the buyer terminal 2 of each buyer. This system conducts reverse auction which determines a contract price or contract unit price of each individual participating buyer by reflecting the procurement quantity of all participating buyers by the above process. Now, the device and program constituting the revere auction system of this embodiment and a reverse auction process flow of this embodiment are described below. The following description describes the case where an object of procurement in joint purchase is a product.

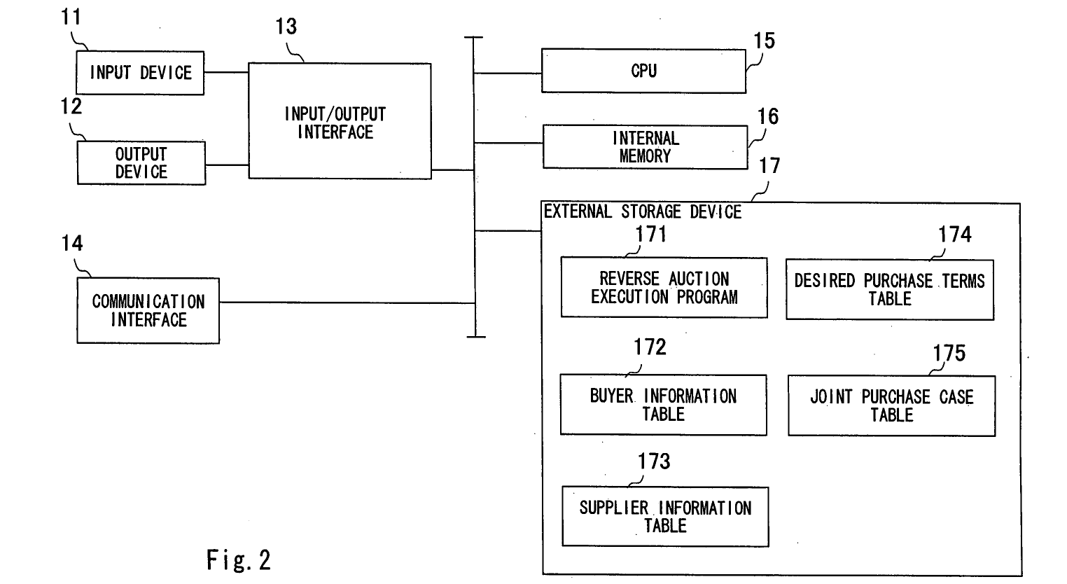

Referring next to FIG. 2, the hardware configuration of the server 1 is shown. The server 1 may be composed of a typical computer system. For example, the server 1 includes an input device 11 such as a keyboard and mouse, an output device 12 such as a monitor and a printer, an input/output interface 13 for controlling their input and output, and a communication interface 14 for transmitting and receiving data through a network such as LAN, telephone network, packet exchange network. The server 1 further includes a CPU 15 for executing arithmetic processing, an internal memory 16, and an external storage device 17. The external storage device 17 may be a hard disk device, for example.

The CPU 15 is a central control unit that executes each processing in the server 1 according to control program. The control program is a program for causing the CPU 15 to execute the processing on the server 1, and it is stored in the internal memory 16 or the external storage device 17. The program may be acquired from remote storage means through the communication network.

The external storage device 17 stores a reverse auction execution program 171. It also stores a buyer information table 172, a supplier information table 173, a desired purchase terms table 174, and a joint purchase case table 175.

The reverse auction execution program 171 is a program for causing the computer system to execute the process of the reverse auction method of the invention. It is loaded to the internal memory 16 and executed on the CPU 15. The CPU 15 operates according to the reverse auction execution program 171, thereby allowing the computer system to operate as the server 1 of this embodiment.

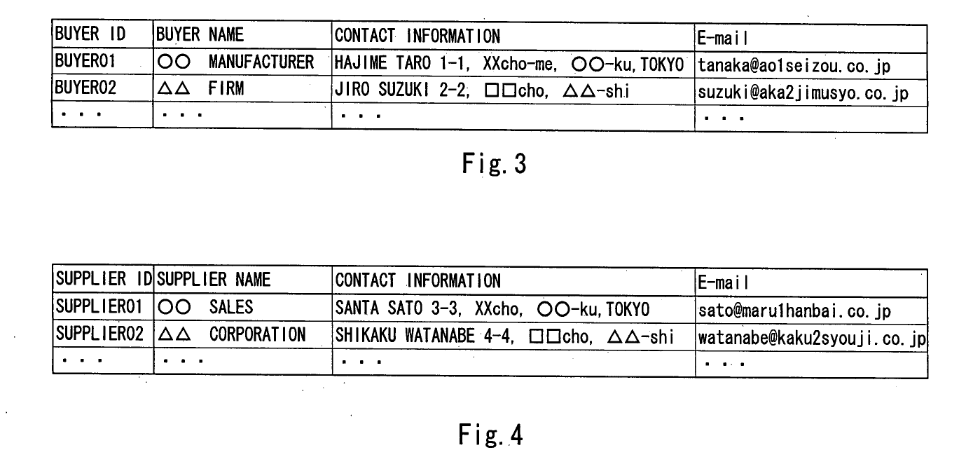

The buyer information table 172 stores information about buyers who are users of the reverse auction service. FIG. 3 shows an example of the buyer information table 172. As shown in FIG. 3, the buyer information table 172 stores information including a buyer name, a buyer ID assigned to each buyer, and buyer contact information. The buyer information is, for example, inputted by an operator through the input device 11 and stored into the internal memory 16 or the external storage device 17 through the input/output interface 13. The buyer information may be acquired from remote storage means through the communication interface 14 or it may be the data inputted by a buyer in the buyer terminal 2 and received through the communication interface 14.

The supplier information table 173 stores information about suppliers who are users of the reverse auction service. FIG. 4 shows an example of the supplier information table 173. As shown in FIG. 4, the supplier information table 173 stores information including a supplier name, a supplier ID assigned to each supplier, and supplier contact information. The supplier information is, for example, inputted by an operator through the input device 11 and stored into the internal memory 16 or the external storage device 17 through the input/output interface 13. The supplier information may be acquired from remote storage means through the communication interface 14 or it may be the data inputted by a supplier in the supplier terminal 3 and received through the communication interface 14.

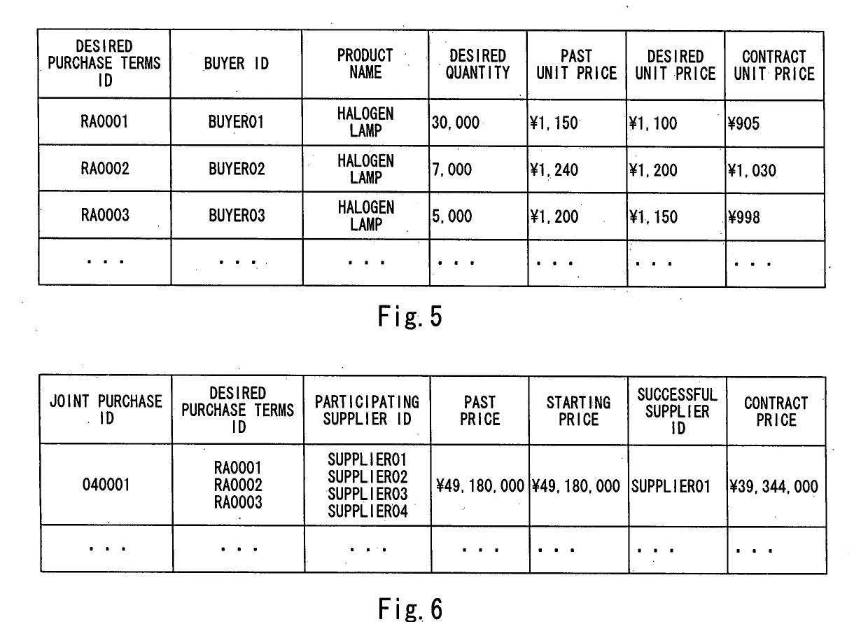

The desired purchase terms table 174 stores information contained in the desired purchase terms transmitted from the buyer terminal 2 and information on a contract price after conducting joint purchase reverse auction. FIG. 5 shows an example of the desired purchase terms table 174. Specifically, information included in the desired purchase terms such as a buyer ID of a buyer intending to procure, the name of a desired product, a past unit price, a desired quantity, and a desired unit price and information containing a contract price determined after joint purchase reverse auction ends are stored in association with a desired purchase terms ID assigned to each desired purchase terms as shown in FIG. 5. The desired purchase terms are inputted from the buyer terminal 2 by a buyer who desires to procure a product, transmitted from the buyer terminal 2 to the server 1, and received through the communication interface 14 and stored in the external storage device 17, for example.

The joint purchase case table 175 stores information required to conduct joint purchase reverse auction and information after conducting joint purchase revere auction in association with each other. FIG. 6 shows an example of the joint purchase case table 175. Specifically, information required for conducting reverse auction such as desired purchase terms ID constituting each joint purchase case, a supplier ID of a participating suppliers, and a starting price of reverse auction, and information determined by conducting reverse auction such as a supplier ID of a successful supplier and a contract price are stored in association with a joint purchase case ID assigned to each joint purchase case, as shown in FIG. 6. The past price is a sum of past prices of participating buyers and the starting price is a price determined for a total purchase amount of participating buyers. The contact price is also a price determined for a total purchase amount of participating buyers.

The buyer terminal 2 is a personal computer (PC), for example, which includes CPU, ROM, RAM, hard disk, display, keyboard, mouse, and so on. The buyer terminal 2 exchanges data with the server 1 by executing Web browser program stored in the hard disk, for example, using TCP/IP, HTTP protocol.

The supplier terminal 3 is also a PC, for examples which includes CPU, ROM, RAM, hard disk, display, keyboard, mouse, and so on. The supplier terminal 3 exchanges data with the server 1 by executing Web browser program stored in the hard disk, for example.

The network 4 is a communication network such as internet, public network, exclusive line, and mobile communication network.

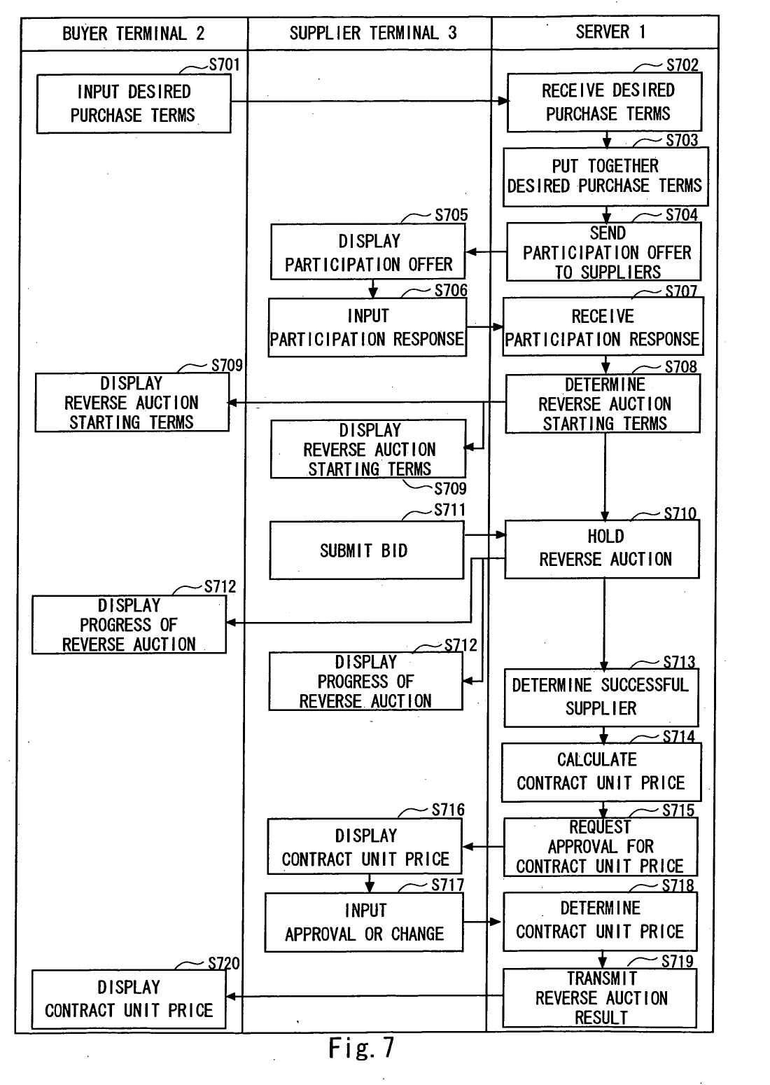

The procedure of the reverse auction of this embodiment is described hereafter with reference to the flow chart of FIG. 7. The process of the server 1 described below is executed by the CPU 15 which operates in collaboration with another hardware configuration according to the reverse auction execution program 171.

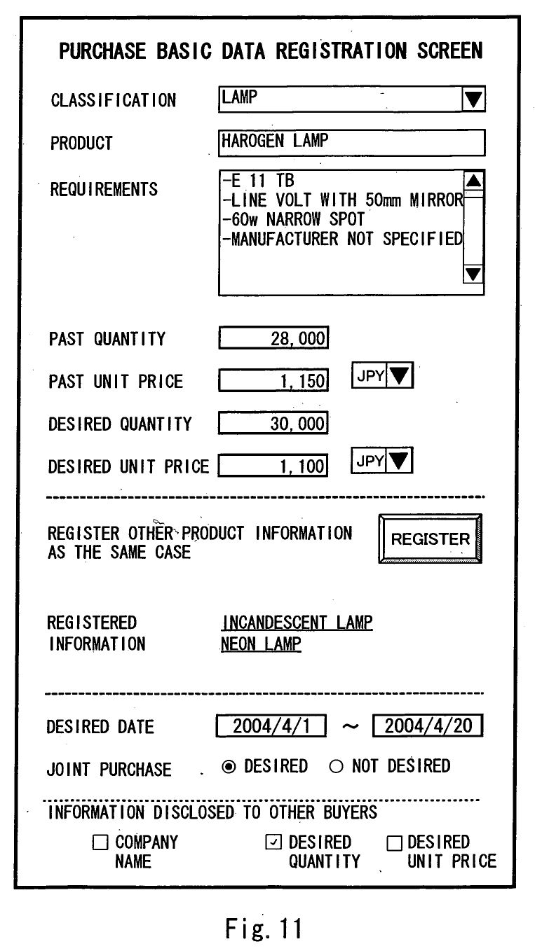

First, the buyer terminal 2 accepts input of desired purchase terms by a buyer and transmits the desired purchase terms to the server 1 (S701). FIG. 11 shows an input screen of desired purchase terms displayed on the buyer terminal 2. The desired purchase terms for the product “halogen lamp” are inputted in this example. The “past quantity” and “past unit price” indicate information on the past purchase history of a buyer for use in determining the starting terms of reverse auction. The “desired quantity” is the number of products the buyer desires to purchase in the reverse auction, and the “desired unit price” is a unit price of a product for purchase in the reverse auction. The “desired date” is a desired period for holding the reverse auction. The screen may further include the sections for inputting presence or absence of intent for joint purchase, limits of information to be disclosed to other buyers, and so on. If a buyer has no past purchase history, the “past quantity” and “past unit price” sections can be left blank in the step S701, and an average amount or a maximum amount of buyers participating in joint purchase may be set as the past unit price of this buyer, which is required in the succeeding step, in the step S702 or S703 described later.

Then, the server 1 receives the desired purchase terms transmitted from the buyer terminal 2 through the communication interface 13 and stores it into the desired purchase terms table 174 in the external storage device 17 in the step S702.

In the step S703, the server 1 determines the desired purchase terms that are put together as a joint purchase case, referring to the desired purchase terms stored in the desired purchase terms table 174. The desired purchase terms may be determined by selecting the terms where a desired product is common and a desired reverse auction date is also common, for example. The selected desired purchase terms are stored as an associated desired purchase terms ID in the joint purchase case table 175. A past price and a starting price are also stored therein. The starting price may be the same as the past price or determined by multiplying the minimum past unit price of the participating buyer with a purchase quantity.

After that, in the step S704, the server 1 transmits a notice of invitation to participate in joint purchase to the supplier terminal 3. At this time, the server 1 also supplies to the supplier terminal 3 the information about the reverse auction case such as a desired product, detailed requirements, desired quantity, desired reverse auction period and reverse auction starting price stored in the joint purchase case table 175 and the desired purchase terms table 174. Instead, the supplier who has received the invitation may access the server 1 through the supplier terminal 3 to browse the information about the reverse auction case.

The supplier terminal 3 displays the received invitation in a display or the like (S705) so that a supplier inputs a participation response, and transmits the response to the server 1 (S706). The server 1 receives the participation response from the supplier terminal 3 (S707). It is preferred that the server 1 stores the supplier ID of the supplier who has returned the participation response in the joint purchase case table 175 in association with the joint purchase case ID.

In the step S708, the server 1 determines starting conditions of the joint purchase case by the information on the participating buyers and suppliers obtained in the preceding steps, and transmits the starting conditions to the buyer terminals 2 of the participating buyers and the supplier terminals 3 of the participating suppliers for confirmation. The buyer terminals 2 and the supplier terminals 3 display the received starting conditions for the participating buyers or the participating suppliers (S709).

After that, the server 1 holds the joint purchase reverse auction (S710). The supplier terminal 3 accepts bid from a supplier and transmits the information to the server 1 (S711). The server 1 compares the bid information transmitted from a plurality of supplier terminals 3 and determines the supplier who has submit the lowest price as a successful supplier (S713). It is preferred that the buyer terminal 2 and the supplier terminal 3 display progress information of the joint purchase reverse auction (S712). The buyer terminal 2 preferably displays the present price, the bidding status of participating suppliers, a remaining time and so on. The supplier terminal 3 preferably displays the present price, a remaining time and so on.

After determining a successful supplier and a contract price, the server 1 determines a contract price or a contract unit price of each of the participating buyers based on their prosecution quantity and past price (S714). A specific process of determining the contract unit price is detailed later.

In the step S715, the server 1 transmits the contract unit price of each buyer determined in the previous step to the supplier terminal 3 of the successful supplier. The supplier terminal 3 displays the contract unit price for the successful supplier (S716) so that the successful supplier inputs approval or change, and transmits the approval or change to the server 1 (S717). Instead, the successful supplier who has received the contract unit price from the server 1 may access to the server 1 through the supplier terminal 3 and input approval or change. Receiving the approval or change of the contract price from the supplier terminal 3, the server 1 corrects the contract unit price in the desired purchase terms table 174 if there is a change, thereby determining the contract unit price (S718).

Finally, the server 1 transmits information on the reverse auction result including the determined contract unit price to the buyer terminals 2 of the participating buyers (S719). The buyer terminals 2 display the reverse auction result for the participating buyers (S720).

If the server 1, the buyer terminal 2, and the supplier terminal 3 operate according to the control flow described above, it is possible to determine a contract unit price of each individual buyer that reflects the procurement quantity and past price of a participating buyer in the joint purchase reverse auction which determines a contract price for a total procurement price of participating buyers.

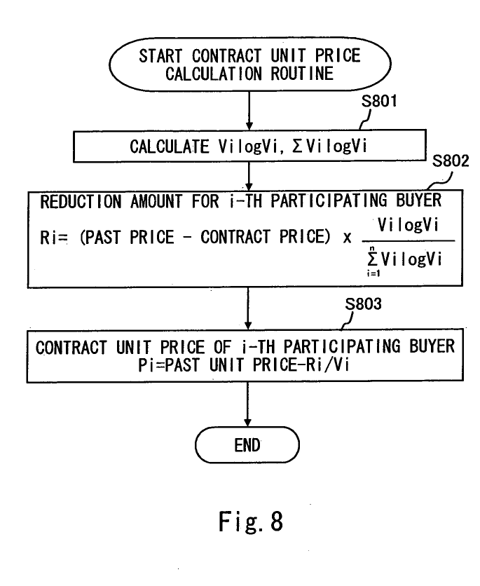

An example of the process of determining a contract unit price in the step S714 is described hereafter with reference to FIG. 8. The step S801 reads out the purchase quantity of a participating buyer from the desired purchase terms table 174 and calculates a factor required for allocating a reduction amount by joint purchase reverse auction. Specifically, it calculates VilogVi for all participating buyers and a sum of VilogVi for all participating buyers (ΣVilogVi), where Vi indicates an expected purchase scale of the i-th participating buyer, which is a desired quantity in this embodiment.

Using the calculation result in S801, the server 1 calculates a reduction amount Ri of each individual participating buyer with the calculation formula shown in S802 of FIG. 8. In FIG. 8, the total number of participating buyers is expressed by n. In the step S803, it subtracts a reduction amount Ri/Vi per unit price from the past unit price of a participating buyer to determine a contract unit price Pi of each individual buyer. The contract unit price is calculated for all the participating buyers and stored in the desired purchase terms table 174.

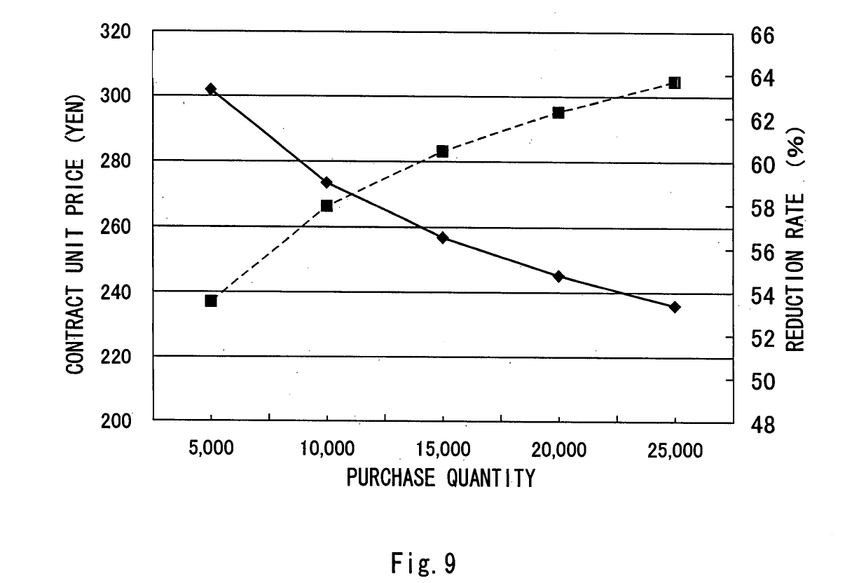

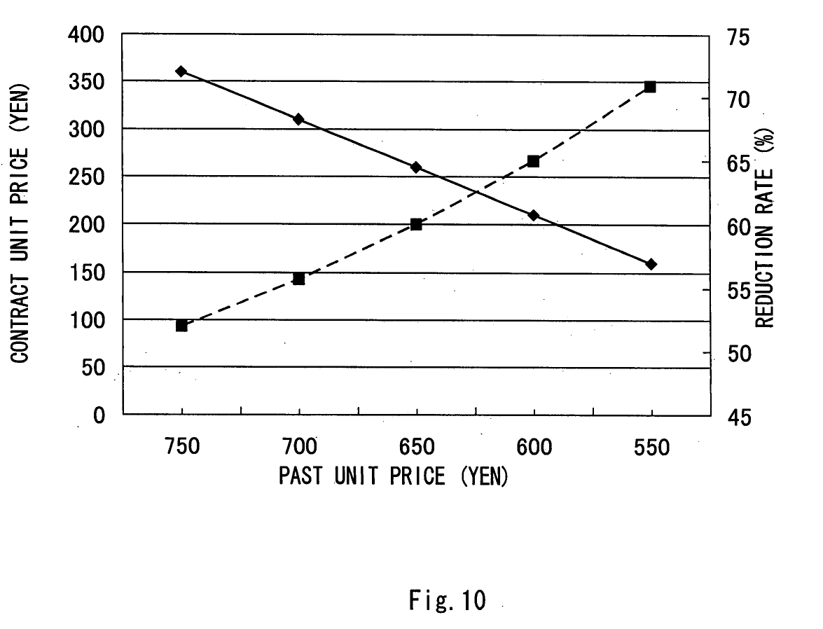

FIGS. 9 and 10 show an example of the relationship between the purchase quantity and the reduction rate of the contract unit price obtained by the process of FIG. 8. FIG. 9 is a graph showing the relationship between each buyer's purchase quantity, contract unit price, and reduction rate obtained by this embodiment in the case where the number of participating buyers is 5, a past unit price of all the participating buyers is ¥650, a purchase quantity is respectively 5000, 10000, 15000, 20000, and 25000, and a reduction rate of a contract price for a total procurement amount with respect to the past price, which is obtained by joint purchase reverse auction, is 60%. In this graph, a solid line indicates the contract unit price and a dotted line indicates the reduction rate.

In this case, the conventional method of setting the price of the contract price for a total amount divided by a total procurement quantity to a contract price results in that the reduction rate of the contract unit price from the past unit price is uniform at 60% for all the participating buyers; thus, the contract unit price is also uniform. In contrast, this embodiment allows the reduction rate to be higher for the participating buyer with a larger purchase quantity. Thus, the contract unit price is lower for the participating buyer with a larger purchase quantity. Specifically, the reduction rate for the buyers with the purchase quantity from 5000 to 25000 is respectively 53.57%, 57.93%, 60.48%, 62.29%, and 63.69%, and the contract unit price is ¥302, ¥273, ¥257, ¥245, and ¥236.

FIG. 10 is a graph showing the relationship between each buyer's past unit price, contract unit price, and reduction rate obtained by this embodiment in the case where the number of participating buyers is 5, a purchase quantity of all participating buyers is 15000, a past unit price is respectively ¥750, ¥700, ¥650, ¥600, and ¥550, and a reduction rate of a contract price with respect to the past price, which is obtained by joint purchase reverse auction, is 60%. In this graph, a solid line indicates the contract unit price and a dotted line indicates the reduction rate. In this case as well, the conventional method of setting the price of the contract price for a total amount divided by a total procurement quantity to a contract price results in that the contract unit price is uniform for all the participating buyers. In contrast, this embodiment allows reflecting a difference in the past unit price between participating buyers as a difference in the contract unit price. Specifically, the contract unit prices for the buyers are ¥360, ¥310, ¥260, ¥210, and ¥160, respectively, and the reduction rate is 52.00%, 55.71%, 60.00%, 65.00%, and 70.91%.

This method allows reflecting the purchase quantity and past price of participating buyers when determining a contract unit price of each individual buyer. It is thus possible to determine the contract unit price of each buyer so that the price reduction rate of the buyer with a large purchase quantity is high.

Though the above description is given on the case where an object of procurement in the reverse auction is a product, this invention is also applicable to the case where an object of procurement is a service or the case where an object of procurement is different products or services. If an object of procurement is a service, the expected purchase scale Vi of the buyer in the contract unit price calculation routine described with reference to FIG. 8 may be a scale of service to be procured. If an object of procurement is different products or services, the expected purchase scale Vi may be an expected price that is a product of a procurement scale and a past unit price.

Further, the above control flow is just an example, and the present invention, which determines a contract price or contract unit price of each individual participating buyer by reflecting their procurement scale and past unit, may be applied to other various control methods which conducts joint purchase reverse auction after matching buyers' desired purchase terms and participating suppliers.

Furthermore, though this embodiment describes the case where the reverse auction execution program 171 is stored in the external storage device 17 such as a hard disk, the program may be stored in a variety of storage media or transmitted through a communication medium. The storage media include a flexible disk, hard disk, magnetic disk, magnetic optical disk, CD-ROM, DVD, ROM cartridge, RAM memory cartridge with battery backup, flash memory cartridge, nonvolatile RAM cartridge, and so on, for example. The communication media include wired communication media such as a telephone line and wireless communication media such as a microwave line, including internet.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A joint purchase reverse auction control method comprising:
determining a contract price for a total procurement amount putting together purchase desires of a plurality of buyers according to a bid by at least one supplier; and
calculating a contract price of each buyer from the contract price for the total procurement amount at least according to a purchase scale or a procurement price prior to reverse auction of the buyer.

2. The reverse auction control method of claim 1, wherein a price per unit quantity of the contract price of each buyer varies by the purchase scale of the buyer.

3. The reverse auction control method of claim 1, wherein the contract price of each buyer is calculated in such a way that a price per unit quantity of the contract price of each buyer is lower for a buyer with a lower procurement price prior to reverse auction.

4. The reverse auction control method of claim 1, wherein the contract price of each buyer is calculated in such a way that a price per unit quantity of the contract price of each buyer is lower for a buyer with a larger purchase scale.

5. The reverse auction control method of claim 1, wherein the contract price of each buyer is calculated in such a way that a price per unit quantity of the contract price of each buyer is lower for a buyer with a larger purchase scale and a lower procurement price prior to reverse auction.

6. The reverse auction control method of claim 1, wherein the contract price of each buyer is calculated by:
calculating a reduction amount of each buyer by dividing a difference between a starting price of reverse auction and the contract price for a total procurement amount by a rate weighted by the purchase scale of the buyer; and
determining an amount where the reduction amount of each buyer is subtracted from a procurement price of each buyer prior to revere auction to be the contract price of each buyer.

7. The reverse auction control method of claim 1, wherein the purchase desires are for a combination of different kinds of items.

8. A computer program product for causing a computer to execute control of joint purchase reverse auction, the computer program product including a computer readable medium storing a program code, the program code comprising:
a first program code determining a contract price for a total procurement amount putting together purchase desires of a plurality of buyers according to a bid by at least one supplier; and
a second program code calculating a contract price of each buyer from the contract price for the total procurement amount at least according to a purchase scale or a procurement price prior to reverse auction of the buyer.

9. A computer program product of claim 8, wherein a price per unit quantity of the contract price of each buyer calculated by the second program code varies by the purchase scale of the buyer.

10. A computer program product of claim 8, wherein the second program code calculates the contract price of each buyer in such a way that a price per unit quantity of the contract price of each buyer is lower for a buyer with a lower procurement price prior to reverse auction.

11. A computer program product of claim 8, wherein the second program code calculates the contract price of each buyer in such a way that a price per unit quantity of the contract price of each buyer is lower for a buyer with a larger purchase scale.

12. A computer program product of claim 8, wherein the second program code calculates the contract price of each buyer in such a way that a price per unit quantity of the contract price of each buyer is lower for a buyer with a larger purchase scale and a lower procurement price prior to reverse auction.

13. A computer program product of claim 8, wherein the second program code calculates a reduction amount of each buyer by dividing a difference between a starting price of reverse auction and the contract price for a total procurement amount by a rate weighted by the purchase scale of the buyer, and determines an amount where the reduction amount of each buyer is subtracted from a procurement price of each buyer prior to revere auction to be the contract price of each buyer.

14. A server for implementing control of joint purchase revere auction, comprising
a unit of determining a contract price for a total procurement amount putting together purchase desires of a plurality of buyers according to a bid by at least one supplier; and
a unit of calculating a contract price of each buyer from the contract price for the total procurement amount at least according to a purchase scale or a procurement price prior to reverse auction of the buyer.

15. The server of claim 14, wherein a price per unit quantity of the contract price of each buyer calculated by the unit of determining a contract price varies by the purchase scale of the buyer.

16. The server of claim 14, wherein the unit of determining a contract price calculates the contract price of each buyer in such a way that a price per unit quantity of the contract price of each buyer is lower for a buyer with a lower procurement price prior to reverse auction.

17. The server of claim 14, wherein the unit of determining a contract price calculates the contract price of each buyer in such a way that a price per unit quantity of the contract price of each buyer is lower for a buyer with a larger purchase scale.

18. The server of claim 14, wherein the unit of determining a contract price calculates the contract price of each buyer in such a way that a price per unit quantity of the contract price of each buyer is lower for a buyer with a larger purchase scale and a lower procurement price prior to reverse auction.

19. The server of claim 14, wherein the unit of determining a contract price calculates a reduction amount of each buyer by dividing a difference between a starting price of reverse auction and the contract price for a total procurement amount by a rate weighted by the purchase scale of the buyer, and determines an amount where the reduction amount of each buyer is subtracted from a procurement price of each buyer prior to revere auction to be the contract price of each buyer.
